(19) United States
(12) Patent Application Publication
(10) Pub. No.: US 2009/0320288 A1
(43) Pub. Date: Dec. 31, 2009

(54) Method for repairing a turbine

(75) Inventors: Alexei P. Yelistratov, Dunlap, IL (US); Marion B. Grant, Princeville, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/216,124

(22) Filed: Jun. 30, 2008

(51) Int. Cl. B23P 6/00

(52) U.S. Cl. 29/889.1

(57) ABSTRACT

A method for facilitating turbine repair is disclosed. The method includes determining wear characteristics of a turbine blade based on at least one of turbine type or turbine application. The method also includes determining a delineated repair area on the turbine blade based on the determined wear characteristics of the turbine blade. The method additionally includes providing a replacement turbine blade part generally matching the size, shape, and material of the turbine blade.

### TECHNICAL FIELD

The present disclosure is directed to a method of repair and, more particularly, to a method for repairing a turbine.

### BACKGROUND

Turbines such as, for example, turbines used in turbochargers, may be driven by exhaust gases from an engine. The exhaust gases may expand while flowing through the turbine with the expansion energy causing the turbine blades to rotate. Because exhaust gases may be at very high temperatures and include combustion particles, significant wear may occur on the blades of the turbine. For example, exhaust gases may cause cracks or bends to develop in the turbine blades. For smaller turbines, entire turbine components are often discarded and replaced at considerable cost instead of being repaired. Smaller turbines may also be repaired using laser deposition techniques such as plasma transferred arc laser spraying, but these techniques are typically costly and labor-intensive.

One attempt at repairing turbines is described in U.S. Pat. No. 7,278,829 B2 (the '829 patent) issued to Roedl et al. The '829 patent discloses a method for replacing an entire squealer tip disposed at an end of a turbine blade. The entire existing squealer tip is removed by grinding away the existing squealer tip material. A new squealer tip, made from a different alloy than the original squealer tip, is then welded to the blade.

Although the repair method of the '829 patent may provide a method for replacing a squealer tip of a turbine blade, it may fail to provide a method for determining a repair based on variables such as turbine type and application. The '829 patent replaces the entire squealer portion of the turbine blade, instead of determining a required repair area based on turbine type or application. Therefore, the repair method of the '829 patent may replace more of the blade than is appropriate for a given turbine, resulting in a substantial waste of materials when numerous turbines are repaired.

The present disclosure is directed to overcoming one or more of the shortcomings set forth above.

### SUMMARY OF THE DISCLOSURE

In accordance with one aspect, the present disclosure is directed toward a method for facilitating turbine repair. The method includes determining wear characteristics of a turbine blade based on at least one of turbine type or turbine application. The method also includes determining a delineated repair area on the turbine blade based on the determined wear characteristics of the turbine blade. The method additionally includes providing a replacement turbine blade part generally matching the size, shape, and material of the turbine blade.

According to another aspect, the present disclosure is directed toward a method for repairing a turbine. The method includes locating a predetermined repair area on a turbine blade. The method also includes removing a portion of the turbine blade corresponding to the predetermined repair area. The method additionally includes attaching a replacement turbine blade part to the turbine blade at the repair area, the replacement turbine blade part having material and dimensions generally matching the removed portion of the blade.

### BRIEF DESCRIPTION OF THE DRAWINGS

FIG. 1 is a schematic illustration of an exemplary turbine wheel;

FIG. 2 is a cross-sectional illustration of the turbine wheel of FIG. 1, taken through a line A-A;

FIG. 3 is a cross-sectional illustration of the turbine wheel of FIG. 1, taken through a line A-A;

FIG. 4 is a cross-sectional illustration of a blade of the turbine wheel of FIG. 1;

FIG. 5 is a cross-sectional illustration of a blade of the turbine wheel of FIG. 1; and

FIG. 6 is a flow chart for an exemplary repair method of the turbine wheel of FIG. 1.

### DETAILED DESCRIPTION

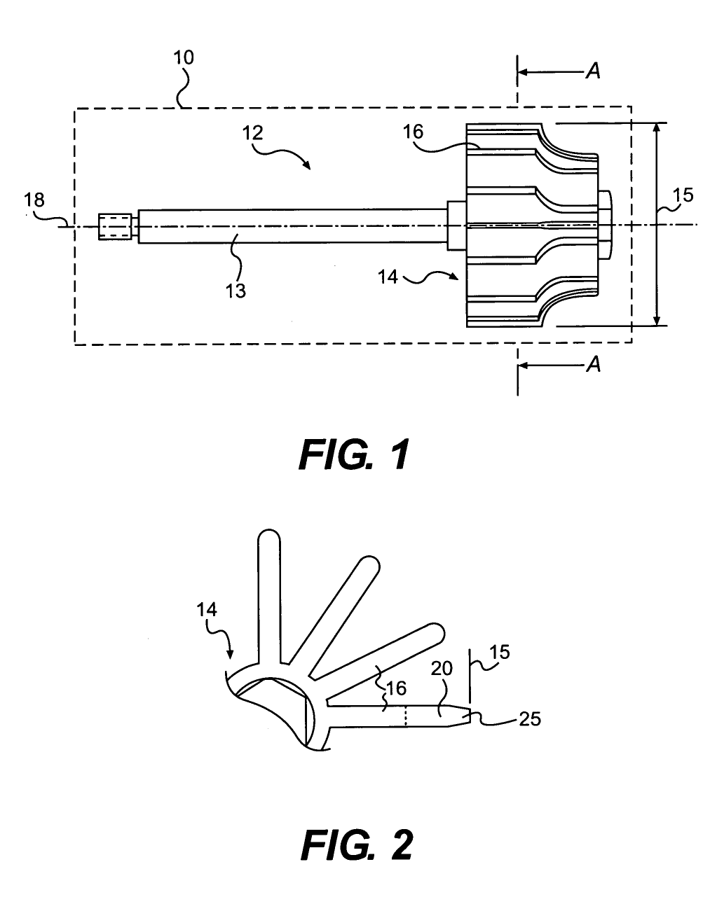

As illustrated in FIG. 1, an engine system for a machine may include a turbine 10 for transferring energy from engine exhaust into mechanical energy for driving other components of the engine system such as, for example, a compressor. Turbine 10 may be located within an exhaust system of a machine so that exhaust gases may expand through turbine 10 to drive a turbine component 12. Turbine component 12 may include a shaft 13, which may be mechanically connected to other engine components, and a wheel 14 having a plurality of blades 16. Blade 16 may be made from any suitable material known in the art such as, for example, nickel-steel or ceramic material. Wheel 14 may have an outer diameter 15, and may be disposed within an exhaust passageway of the exhaust system so that the exhaust gases expand on the blades 16. Turbine component 12 may be mounted within turbine 10 so that turbine component 12 rotates about an axis 18 as exhaust gases drive blade 16.

As the exhaust gases expand against blade 16 at high temperature and velocity, solid particles contained within the exhaust may strike blade 16, causing deterioration. The wear characteristics of blade 16 (i.e., a manner in which the exhaust gases affect blade 16) may vary based on any engineering variable associated with turbine operation such as, for example, turbine application and type. Turbine type factors affecting the wear characteristics of blade 16 may include, for example, a size of turbine 10, whether turbine 10 is shrouded or shroudless, and whether turbine 10 is contra-rotating. Turbine application factors affecting the wear characteristics of blade 16 may include, for example, whether turbine 10 is a turbocharger, supercharger, turbopump, or turboexpander. The amount and locations of deterioration occurring on blades 16 may vary as the type and application of turbine 10 varies. Determining the wear characteristics of blade 16 may include accounting for locations of blade 16 that may be prone to developing more significant amounts of wear than other locations of blade 16. The wear characteristics of blade 16 may be determined empirically through experience and observation, theoretically through calculation, by dynamic modeling, or by any other suitable engineering methodology known in the art.

A delineated repair area 20 may be determined based on the determined wear characteristics of blade 16. Delineated repair area 20 may be predetermined (i.e., determined before turbine 10 is put into service). Delineated repair area 20 may be a spatial representation of the wear characteristics of blade 16 that may cause turbine 10 to operate improperly. For example, for a given type and application of turbine 10, blade 16 may be determined to have wear characteristics of becoming deteriorated near outer diameter 15 to an extent that turbine 10 operates improperly. Delineated repair area 20 may be determined so that it envelopes (i.e., completely includes) the locations on a blade 16 that may become deteriorated from exhaust gases and affect turbine 10 to operate improperly. Delineated repair area 20 includes a portion of blade 16 that is less than the entire blade 16. Because delineated repair area 20 may include only a portion of blade 16, significant savings in material may be achieved by avoiding an unnecessary removal of an entire blade 16. The size and shape of the delineated repair area 20 may be labeled on blade 16 by any suitable method known in the art such as, for example, marking blade 16 itself, or marking a physical model or a computer-aided design (CAD) model of blade 16. A repair schedule may be developed that provides a plurality of delineated repair areas 20 for various types, applications, and other engineering variables affecting turbine 10. The repair schedule may indicate when to attach the insert 26 to blade 16. It is contemplated that the blade repair method may be applicable to a plurality of blades 16 of turbine wheel 14.

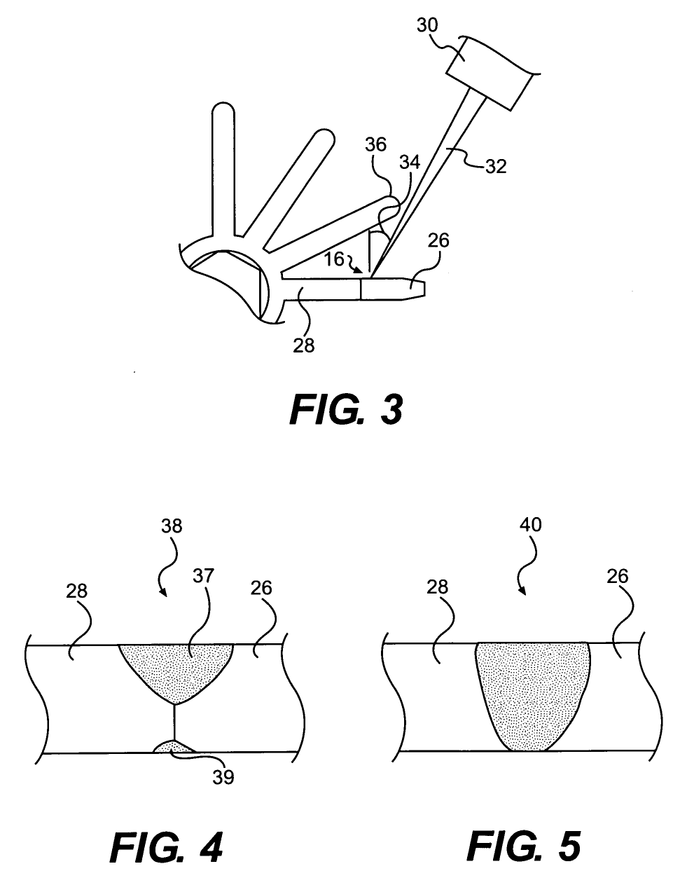

Referring to FIG. 3, an insert 26 that generally matches the size, shape, and material of delineated repair area 20 of blade 16 may be fabricated. Because delineated repair area 20 may be determined prior to any operational wear forming on blade 16, insert 26 may be similarly prefabricated prior to any operational wear of turbine 10, in preparation for a possible repair of turbine 10. Insert 26 may be a replacement turbine blade part formed by any suitable method known in the art for forming complex geometrical shapes such as, for example, investment casting. If investment casting is used, a wax model of insert 26 may be formed and placed into a housing. The housing may be filled with plaster, surrounding the wax model. After the plaster has cured, the container may be heated in a kiln, causing the wax to vaporize and leaving a hollow area. Molten metal of the same composition as blade 16 may be poured into the hollow area, forming insert 26. Because investment casting may allow the formation of complex shapes, insert 26 may require no machining once it is cast.

Turbine 10 may be monitored for indications of deterioration and periodically inspected during its service life. When actual deterioration is observed on blade 16 that approaches an extent of delineated repair area 20, thereby potentially affecting turbine 10 to operate improperly, blade 16 may be repaired. Delineated repair area 20 includes only a part of blade 16, and a portion 25 of blade 16 that generally matches delineated repair area 20 may be removed, as illustrated in FIG. 2. Portion 25 may be removed by any suitable method known in the art such as, for example, laser cutting. Portion 25 may be any portion of blade 16 such as, for example, a tip portion located near outer diameter 15 or a portion located near a center of blade 16.

After portion 25 has been removed, insert 26 may be attached to a remaining portion 28 of blade 16 as illustrated in FIG. 3. Insert 26 may be initially attached to remaining portion 28 by any suitable fixture device known in the art for aligning elements to be welded. Alternatively, tack welding may be appropriate in certain applications such as, for example, when turbine 10 is a relatively large turbine. After insert 26 is initially attached to remaining portion 28, insert 26 may be welded to remaining portion 28 via a laser 30. Laser 30 may be any suitable laser known in the art for laser beam welding such as, for example, a diode laser. Laser 30 may be a low-power laser and may generate a laser beam 32 by passing electrical current through a diode to generate very intense light. Laser 30 may perform welding at an angle 34 from a plane perpendicular to blade 16. Angle 34 may be large enough to allow laser 30 adequate clearance so that laser beam 32 may clear an end 36 of an adjacent blade. Therefore, angle 34 may vary as a function of a geometry of wheel 14 and blades 16. Laser beam 32 may have relatively low reflectivity so that an effectiveness of laser beam 32 is not significantly reduced when operating at angle 34 from the plane perpendicular to blade 16.

Laser 30 may weld insert 26 to remaining portion 28 by any suitable welding method known in the art such as, for example, butt-welding. Butt-welding may be an autogenous welding method that requires no filler or additional welding material. As illustrated in FIG. 4, a butt weld 38 may used to connect insert 26 to remaining portion 28. Laser beam 32 may form butt weld 38 by providing partial penetration from only one side of blade 16. The partial penetration may be from approximately 50% to 75% of a thickness of insert 26 and remaining portion 28 at a location 37. Laser beam 32 may additionally weld an opposite side of butt weld 38 at a location 39 without substantial penetration. As illustrated in FIG. 5, an alternative butt weld 40 may be used to connect insert 26 to remaining portion 28. Laser beam 32 may form the alternative butt weld 40 by providing full penetration from only one side of blade 16, with no welding required from an opposite side. If butt welds 38 and 40 are of good quality, then no additional machining may be required to finish the repair.

### INDUSTRIAL APPLICABILITY

The disclosed method may provide a repair for turbine 10 accounting for wear characteristics of blade 16 that may vary as a function of turbine type and application. Because delineated repair area 20 may be determined based on variables such as turbine type and application, only part of a blade 16 may be replaced, saving significant cost and materials when numerous repairs are made. Additionally, because insert 26 may be pre-fabricated based on dimensions of delineated repair area 20 and maintained on hand, turbine 10 may be quickly repaired. A quick repair of turbine 10 may reduce the amount of time turbine 10 is taken out of service, which may increase productivity.

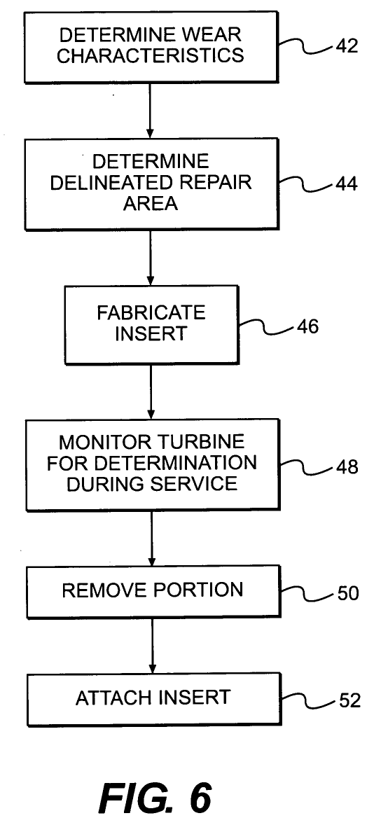

Turbine 10 may be repaired by method steps 42, 44, 46, 48, 50, and 52, illustrated in FIG. 6. Steps 42, 44, and 46 may be performed by engineering personnel before turbine 10 is put into service, but may also occur while turbine 10 is in service. In step 42, the wear characteristics of blade 16 may be determined based on variables such as turbine type and turbine application. In step 44, delineated repair area 20 may be determined as a function of the wear characteristics of step 42. As noted above, delineated repair area 20 will be only a portion of blade 16 and may be a spatial representation of the wear characteristics of blade 16 that may cause turbine 10 to operate improperly. The determined size and shape of delineated repair area 20 may be marked on blade 16 itself, or marked in a CAD program and/or physical model that is available to maintenance personnel for turbine 10, and may be included in a repair schedule. In step 46, insert 26 may be fabricated and provided to turbine maintenance personnel. Depending on the number of turbines 10 in operation, maintenance personnel may maintain numerous inserts 26 on-hand to facilitate quick repairs.

In step 48, turbine 10 may be put into service. Maintenance personnel may monitor turbine 10 by periodically inspecting blade 16 for deterioration. Maintenance personnel may refer to the repair schedule to compare delineated repair area 20 to any indication of deterioration on blade 16. When actual deterioration on blade 16 approaches an extent of delineated repair area 20, maintenance personnel may obtain an appropriate insert 26, according to the repair schedule, and stop the operation of turbine 10. To improve maintenance efficiency, maintenance personnel may coordinate the simultaneous repair of several blades 16 and/or numerous turbines 10.

In step 50, maintenance personnel may use delineated repair area 20 as a reference to remove portion 25 from blade 16. In step 52, maintenance personnel may attach insert 26 to remaining portion 28 of blade 16, and turbine 10 may be put back into service.

As noted above, the method of FIG. 6 may provide an indication of the point at which wear becomes problematic for the operation of turbine 10. The method of FIG. 6 may provide a less expensive repair than replacing the entire blade 16 or turbine wheel 14. The method of FIG. 6 may also provide for prefabricated inserts 26 to be maintained on hand, reducing the amount of time that turbine 10 may be taken out of service to make repairs.

It will be apparent to those skilled in the art that various modifications and variations can be made to the disclosed repair method. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for facilitating turbine repair, comprising:
determining wear characteristics of a turbine blade based on at least one of turbine type or turbine application;
determining a delineated repair area on the turbine blade based on the determined wear characteristics of the turbine blade; and
providing a replacement turbine blade part generally matching the size, shape, and material of the turbine blade.

2. The method of claim 1, wherein the replacement turbine blade part includes less than the entire turbine blade.

3. The method of claim 1, further including developing a repair schedule indicating when to attach the replacement turbine blade part to the turbine blade.

4. The method of claim 1, further including fabricating the replacement turbine blade part by investment casting.

5. The method of claim 1, wherein the providing of a replacement turbine blade part includes providing the replacement turbine blade part prior to any operational wear of the turbine blade.

6. The method of claim 1, wherein the providing of a replacement turbine blade part includes providing a plurality of replacement turbine blade parts.

7. A method for repairing a turbine, comprising:
locating a predetermined repair area on a turbine blade;
removing a portion of the turbine blade corresponding to the predetermined repair area; and
attaching a replacement turbine blade part to the turbine blade at the repair area, the replacement turbine blade part having material and dimensions generally matching the removed portion of the turbine blade.

8. The method of claim 7, wherein the predetermined repair area is determined from wear characteristics of the turbine blade

9. The method of claim 7, further including monitoring the turbine for indications of deterioration.

10. The method of claim 7, wherein the removing of the portion of the turbine blade includes removing by laser cutting.

11. The method of claim 7, further including initially attaching the replacement turbine blade part to the turbine blade via a fixture device.

12. The method of claim 7, further including initially attaching the replacement turbine blade part to the turbine blade via tack welding.

13. The method of claim 7, wherein the replacement turbine blade part includes less than the entire turbine blade.

14. The method of claim 7, wherein the replacement turbine blade part is manufactured prior to any operational wear of the turbine.

15. A method for repairing a turbine, comprising:
locating a predetermined repair area on a turbine blade, the predetermined repair area determined from wear characteristics of the turbine blade;
removing a portion of the turbine blade corresponding to the predetermined repair area; and
laser welding a replacement turbine blade part to the turbine blade at the repair area with an autogenous weld, the replacement turbine blade part having dimensions generally matching the removed portion of the turbine blade.

16. The method of claim 15, wherein laser welding is performed at an angle large enough from a plane perpendicular to the turbine blade to allow a laser adequate clearance from an adjacent turbine blade.

17. The method of claim 16, wherein the angle varies as function of a geometry of the turbine.

18. The method of claim 15, wherein the autogenous weld is a butt weld having partial penetration of approximately 50% to 75% of a thickness of the turbine blade.

19. The method of claim 15, wherein the autogenous weld is a butt weld having full penetration.

20. The method of claim 15, wherein laser welding is performed via a low-power laser having low reflectivity.
